(19) United States
(12) Patent Application Publication
(10) Pub. No.: US 2003/0126133 A1
(43) Pub. Date: Jul. 3, 2003

(54) Database replication using application program event playback

(75) Inventors: Kayshav Dattatri, San Jose, CA (US); Guru Prasad, San Mateo, CA (US); Viral Kadakia, Sunnyvale, CA (US); Pravin Singhal, Cupertino, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: SlamDunk Networks, Inc., Redwood City, CA

(21) Appl. No.: 10/033,701

(22) Filed: Dec. 27, 2001

(51) Int. Cl. G06F 7/00

(52) U.S. Cl. 707/10

(57) ABSTRACT

A system for updating and maintaining multiple copies of a database. An application program sends events to a database server at a primary data site to update, or otherwise modify, data in data store at the site. A tracking process at the database server enters event information into an event log. The event log is sent to other data sites where the record of events is used to recreate modifications to copies of the primary data site's data store. This approach allows multiple other data stores at different data sites to be similarly updated. Event logs, and portions of event logs, can be transferred among data sites with a minimum of coordination and verification, and used to update copies of a data store, or other information. Portions of event logs can be received at a site “out-of-order” from the recording of events at the primary site. When a primary site fails, another site whose data store is sufficiently updated with the event log data can assume the role of primary site. If the original primary site comes back on line then it can be updated with event log data from the second primary site and re-assume primary operations, or remain as a secondary site.

### BACKGROUND OF THE INVENTION

This invention relates in general to digital processing systems and more specifically to a system for updating, or synchronizing, datastores to a primary database by using application program events.

Today's computer networks, such as the Internet, corporate and campus intranets, local area networks, etc., are used in many aspects of business, financial, education, entertainment and other areas. In many of these applications it is critical that information not be lost or corrupted. One popular approach to ensure that data is not lost is to maintain redundant copies of the data in separate locations. This allows a data system to use one of the copies of data in case the original data is corrupted or becomes unavailable such as when a computer malfunctions, becomes inaccessible, etc. Redundant copies of data are also useful to check data integrity. That is, if multiple copies are maintained then if one copy is different from the other copies, the different copy can be flagged as probably being in error.

One type of data that is often important to backup accurately is a database, or data store, used with a data server. Typical databases can be, e.g., Oracle, Access, dBII, etc. The databases can be maintained by many different types of operating systems and computer hardware. A combination of an operating system, or operating environment, and the computer hardware on which it runs is called a “platform.” It is often very important to ensure integrity of every item in a database because the data is the core with which other application programs, or processes, operate. For example, in a database of financial transactions it is not permissible to have a single error in the data in the database.

However, it is difficult to maintain up-to-date and error-free copies of databases. Typically a database is extremely large. Even more troublesome, the database can be updated many hundreds, thousands, or more, times per second. To further complicate matters, a database may be running on multiple computers or systems. Often, a large system may have multiple databases running on different platforms. Several different application programs, or other processes, can be communicating with the database to store, retrieve and modify the stored data.

One approach that the prior art uses to maintain multiple copies of a database is to run multiple database systems. Each database system includes a data store and a database server. The database server generates database operations, or “transactions,” in the database's native query language. The database server generates the database transactions in response to external requests or commands received by the database server from application programs, or processes. The application programs typically send requests for data, requests to update data, or send queries on the database for which a result is returned. The communications from the application program to the database server are called “events.”

Where redundancy is desired, each event to a primary database server is also sent to a secondary “tracking” server that is associated with a different, secondary database. The secondary tracking server generates the same transactions to the secondary database that the primary tracking server generates to the primary database. In this manner, every modification to the primary database is also performed to the secondary database. Typically, the secondary database need not be updated on a transaction-by-transaction basis. Instead, the tracking server maintains a “transaction log” which is a record of all of the transactions to be performed on the secondary database. The transactions can then be performed at a later time.

Problems with the transaction tracking approach of the prior art include cases where very large numbers of transactions can accumulate in a very short time. This takes up storage or requires frequent updating of the secondary database to reduce the size of the transaction log. Also, the database query languages can be different for different databases. It is not possible, for example, to maintain an efficient copy of a first database on a second database where the databases are different types (e.g., different manufacturers). Even where the databases are of the same types, the execution of the databases on different platforms may introduce incompatibilities at the transaction level.

### SUMMARY OF THE INVENTION

A system for updating and maintaining multiple copies of a database. An application program sends events to a database server at a primary data site to update, or otherwise modify, data in data store at the site. A tracking process at the database server enters event information into an event log. The event log is sent to other data sites where the record of events is used to recreate modifications to copies of the primary data site's data store.

This approach allows multiple other data stores at different data sites to be similarly updated. Event logs, and portions of event logs, can be transferred among data sites with a minimum of coordination and verification, and used to update copies of a data store, or other information. Portions of event logs can be received at a site “out-of-order” from the recording of events at the primary site. When a primary site fails, another site whose data store is sufficiently updated with the event log data can assume the role of primary site. If the original primary site comes back on line then it can be updated with event log data from the second primary site and re-assume primary operations, or remain as a secondary site.

In one embodiment the invention provides a method for keeping a copy of data, wherein a primary database server is coupled to a primary data store and wherein the primary database server receives database events from an external source and generates signals for accessing the primary data store. The method includes steps of using the tracking process to store at least a portion of the received database events in an event log; and using the event log to update a secondary data store.

### BRIEF DESCRIPTION OF THE DRAWINGS

FIG. 1 illustrates basic features of the invention;

FIG. 2A shows a primary and multiple secondary database sites; and

FIG. 2B shows the system of FIG. 2A after failure of the primary database site.

### DETAILED DESCRIPTION OF A PREFERRED EMBODIMENT

A preferred embodiment of the present invention is applied to a messaging network manufactured by Slam Dunk, Inc. Aspects of this messaging system can be found in the co-pending patent application cited above. However, other types of systems and applications can be used with the present invention. Features of the present invention can be applied to any type of data backup and recovery, both in standalone systems or in large and small networked systems such as those that use the Internet, local-area networks (LANs), campus networks, etc. Combinations of different systems can be used.

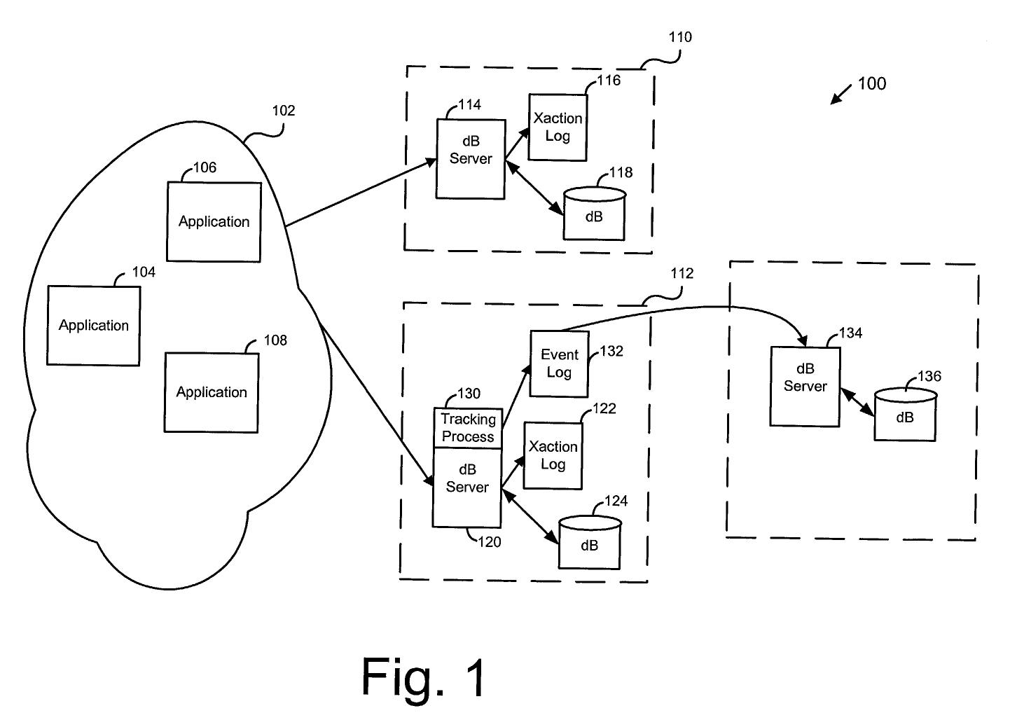

FIG. 1 illustrates network database system 100.

Database system 100 includes application programs (or tasks, threads or other processes) executing on different devices and connected by a network, such as the Internet. Any collection of processes operating on any type of processing device with any interconnection scheme can be suitable for use with the present invention and are shown, collectively as network 102. Database sites such as 110 and 112 can be located geographically remote from applications and devices in network 102. The database sites, and their associated components, can be of various types and can run on different platforms. In general, many types of digital hardware and software are suitable for use as application programs and as database sites for use with the present invention. The organization of hardware and software can vary widely and be very different from the organization shown in FIG. 1.

Database site 110 includes database server 114 for receiving requests for database information and for modifying, managing or otherwise processing data. Data is stored in data store 118. Transaction log 116 is maintained to keep a record of database transactions between database server 114 and data store 118. Typically, database server 114 receives commands, instructions, or other information, called “events,” from an application program on the network. The database server generates transaction requests in response to the received events. The transaction requests are issued to the data store in a query language that is native to the data store. For example, SQL, Access or dBII query languages can be used with their appropriate data stores. A data store can be an operational data store (ODS), data warehouse, or other type of data storage process, device or collection of processes and/or devices.

Every transaction that affects the data store is recorded in a transaction log such as transaction log 116. This allows the transaction log entries to be used to update another data store (not shown). For example, the transaction log can be transferred over network 102 to another database site and used to update a data store. Thus, an accurate copy of data store 118 can be maintained. Each database site typically manages and uses its own transaction log. In practice, transaction logs are usually used at a single site and are not commonly used to update other sites.

Database site 112 includes similar components to database site 110, but also includes features of the present invention to maintain an event log.

In FIG. 1, database site 112 includes database server 120, data store 124 and transaction log 122. These components function similarly to the components of database site 110, discussed above. Database site 112 also includes tracking process 130 and event log 132. Tracking process 130 acts to filter and store events exchanged between application programs (or other processes) and database server 120. In a preferred embodiment, tracking process 130 can be configured to track different types of events and to exclude other events. For example, events can be classified based on status. In the case of a messaging system, event status can include whether a message was sent, how long since sent, whether the message was received, etc. The status indications can be used to filter use of events, create presentations of information for human users, give priority to types of datastore updates, or for other purposes.

Some types of events might make prior events irrelevant. In such cases, the prior events can simply be discarded so that the size of the event log is reduced and so that the later act of using the event log to update a copy of the data store is minimized. A simple example is where a record is overwritten twice. In this case, the first overwrite can be omitted as an event. Another example is to configure one of multiple secondary databases to accept only events with errors. Thus, a database can be used to count, or log, error messages for troubleshooting.

Event log 132 can be used from time-to-time to update an external copy of the data. The external copy can be local or remote from the original copy in data store 124. In FIG. 1, event log 132 is used to send events to database server 134 which, in turn, updates secondary data store 136. This approach has the advantage that it is independent of the transactions and query language of the data store. In a preferred embodiment, a tracking server is used to convert event data from a canonical form into a database-acceptable form prior to writing the data to the event logs. In effect, the tracking server performs a pre-processing, or “front end,” function. As discussed below, provision can be made for updating multiple data stores in an “N-way replication” of data.

The secondary data store can have a transaction log associated with it, although for purposes of making a backup copy on the secondary data store it is not necessary. Note that many database system architectures exists, so that some implementations may have additional components than those shown in the accompanying Figures. Also, some components may be omitted as, for example, where the database server is integrated into, or with, the data store.

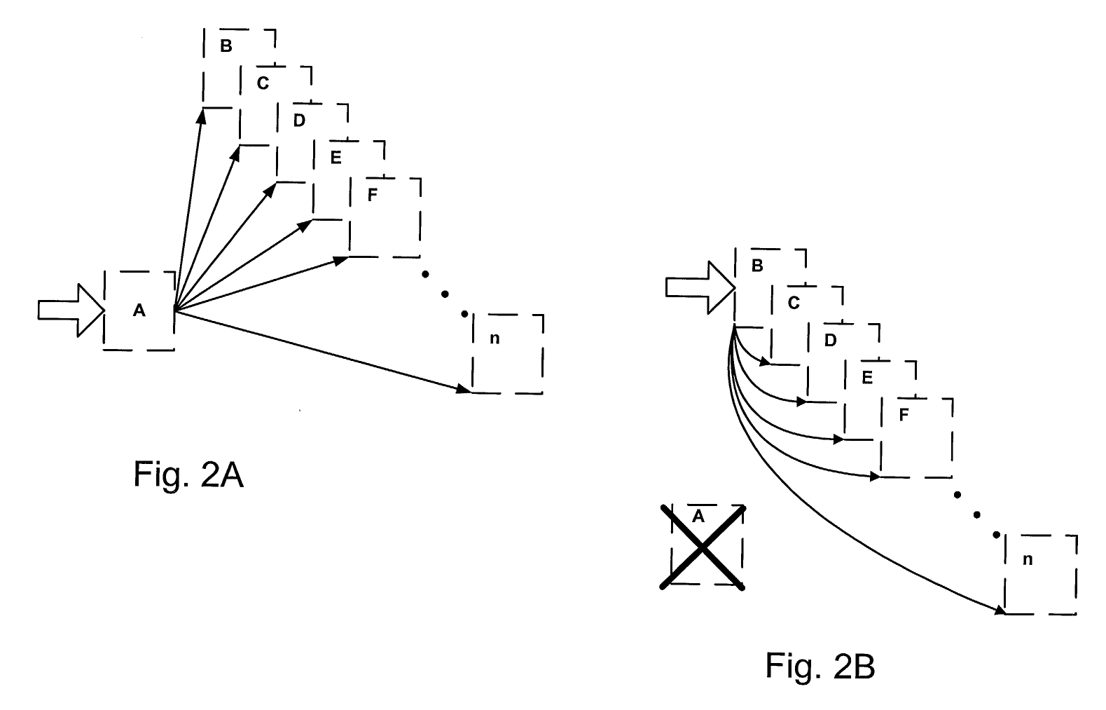

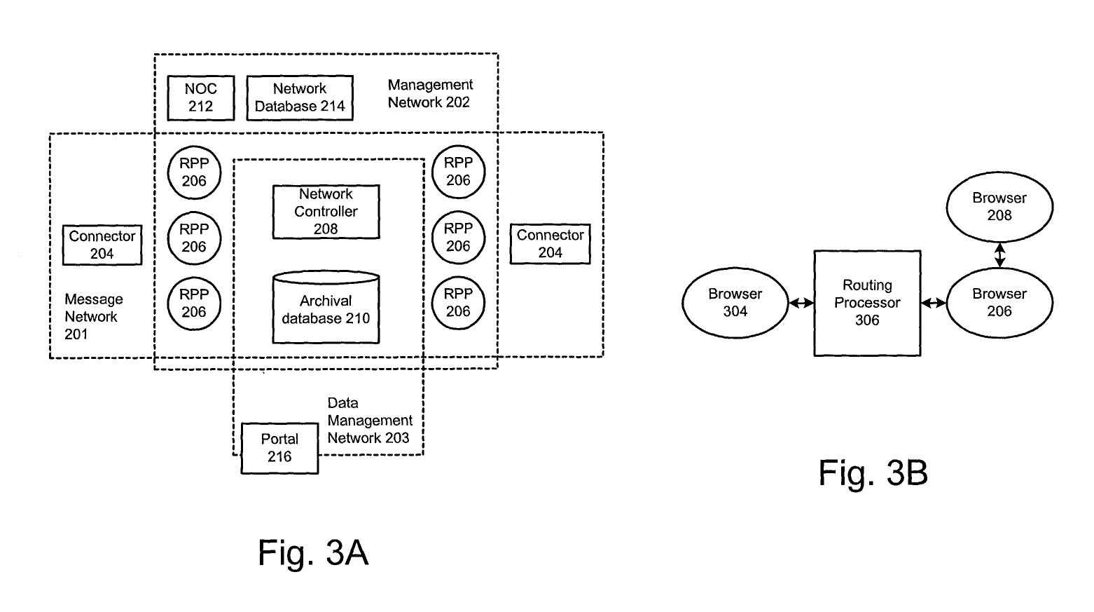

FIG. 2A illustrates multiple database backup. In FIG. 2A, primary database site A receives application program events. The events are selectively recorded into an event log and the event log is used to synchronize, or update, other copies of the data at other database sites, e.g., at B, C, D, E, F and n. By using the event log to update secondary database sites (as discussed above, in connection with FIG. 1) the database updates can take place in parallel without the need for further communication among primary and secondary sites. Note that any number, type and arrangement of database sites, and their associated components, are possible. The database sites that cooperate together to ensure data backup and recovery are referred to here as a “set.”

In FIG. 2A, a database server and other components at database site A are referred to as a “master” while servers and components at the secondary sites are “slaves.” The primary/master database site is the only site to receive events as shown by the arrowhead. The secondary/slave databases receive updates only in the form of portions of the recorded event log from the primary/master. This approach makes failure recovery more efficient.

Note that in the n-way replication shown in FIG. 2A, updates to the secondary sites need not be done at the same time. For example, sites B and C can be updated every few minutes while the other sites are updated only once per day. In case site A fails, sites B or C can quickly be used to replace site A, as discussed below, while other sites provide additional backup at lower overhead due to the less frequent synchronization interval. Also, passing of the event log information need not be in the “hub and spoke” topology shown in FIG. 2A. For example, the event log information can be passed from site to site in a daisy chain fashion, or in any other manner.

Updating of secondary database sites is asynchronous and independent. Updates can take place at any time and can be done without regard to the state of the primary database or other secondary databases.

FIG. 2B illustrates the system of FIG. 2A after a failure, or “failover,” of database site A has occurred.

In FIG. 2B, database site A has failed and is no longer available for operation. A “failover” protocol is used to migrate responsibility to a new master. A master and slave arrangement is referred to as a “service group.” In a preferred embodiment the service group includes a domain name server (DNS) name and special, or required, processes, if any. In some cases, internal dynamic state changes may be necessary to permit a successful migration.

In FIG. 2B, after failover, database site B assumes the role of master and events are redirected to database site B. Database site B uses a record of slaves of site A to ensure that event log data is propagated to the sites that belong to the set. As can be seen, site B continues to propagate event logs to all of the remaining sites in the set. Similarly, another site can assume the role of master if site B fails, and so on.

If site A is brought back up to operational state, the data at site A can be updated with the proper event log information from site B, or another site. Site A can then assume the master role. Alternatively, site A can be placed in a slave role. Note that the slaves do not have to use the event log data as soon as it is received. Slaves can keep the event log data on-hand and only perform the updating of their data stores when needed, or at predetermined intervals, etc.

Different portions of event logs can be obtained from different sites, even out-of-order. The portions can be used to build up a more complete event log, as needed. Since there is only one site that is generating event log information less checking is needed to make sure that accurate and non-conflicting events are used.

This approach also means that the primary (master) system is essentially stateless as far as replication is concerned as most of the state is maintained by redundant instances, or secondary sites. This permits easier and error-free migration, and provides for scalability. Note that adding additional secondary sites does not significantly increase resource consumption or complexity at the master. This is due, in part, by not requiring event logs to be “pushed” from the master to the slaves. Instead, the event logs are provided by the master to the slaves on a demand-only basis. Other embodiments can use different arrangements (including “push”) to distribute event logs.

One desirable arrangement is “daisy chaining” of a series of slaves in a predetermined order. The master passes the event log to the first slave in the chain, who passes it to the next slave, and so on. When the master fails, the first slave in the chain assumes the role of the master and passes the event log to the second slave who continues to pass the event log down the chain. In this manner, the addition of more slaves to the chain does not increase the burden to the current master at all.

A preferred embodiment of the present invention is intended for use in a messaging system described in the following paragraphs. The system is described in detail co-pending U.S. patent application Ser. No. 09/740,521 filed Dec. 18, 2000, entitled SYSTEM FOR HANDLING INFORMATION AND INFORMATION TRANSFERS IN A COMPUTER NETWORK.

FIG. 3A shows the topology of network 200. In FIG. 3A, the network is partitioned into three virtual networks referred to as message delivery network 201, management network 202, and data management network 203. The message delivery network employs logical and physical components referred to as connectors, route point processors and archives to move messages from the source to the destination.

Management network 202 monitors and manages operational features of network components. Management network 202 includes network operations center (NOC) 212 and network database 214. The dotted lines in FIG. 3A show the logical configuration of the networks and how various components are associated with different networks depending on the particular function being performed. The overlap of the networks is illustrated with reference to management network 202 where NOC 212 dedicated to monitoring the physical status of the respective components and the communication backbone of message delivery network 201. When NOC is notified of a problem, alert messages are transmitted to network managers or other personnel responsible for maintaining the network system. The alert message is transmitted either by e-mail, fax, telephone, pager, or other communication means such that appropriate personnel and repair equipment are timely dispatched to correct the problem. NOC 212 employs commercially available network management tools, to remotely identify and correct the cause of the problem. Network controller 208 and NOC 212 utilize a shared network database 214 to exchange status information regarding the operational status of the network.

Data management network 203 provides a user having appropriate security access to query archival database 210 for data mining and monitoring performance parameters of message network 201. As with management network 202, data management network 203 encompasses portions of the message network 201 and more specifically, route point processors 206, network controller 208, and archival database 210. Data management network 203 further includes a portal 216. Portal 216 enables end-users or application programs to access the data stored in archival database 210 to provide accounting, configuration, and performance information, as well as other value-added services which may be accessed through the API defined by portal 216. Access to the archive database is obtained through a data management network which defines a common API access through a portal. The portal access provides an opportunity for off-line analysis and enables the user to regenerate or to define alternative databases conveying various levels of information and functionality.

Message delivery network 201 includes a plurality of connectors 204 through which B2B/EDI applications or users gain access to the message delivery network. Although only two connectors 204 are illustrated in FIG. 3A, it should be apparent to one skilled in the art that the numbers of connectors is not limited because the connectors are software components that may populate any end user or application server.

Each connector 204 provides the necessary interface between the message delivery network 201 and the respective source and destination application or user. More specifically, connectors are the main workhorses of message delivery network 201. Each connector is responsible for encryption, compression, XML packaging, address resolution, duplicate message filtering and error recovery.

A portion of connectors 204 distributed throughout message network 201 may be deployed as standalone connectors which are illustrated in FIG. 3B. Standalone connectors are either client based or network based, operate outside B2B/EDI system environments and provide connection to message network 201 from any browser 304 via an Internet connection. Standalone connectors comprise a software module referred to as a routing processor 302 which contains the logic necessary to interface to message network 201. The primary responsibility of routing processor 302 is to establish connection with selected route point processors 206 in accordance with network configuration data obtained from network controller 208.

In a preferred embodiment, a tracking process executes wherever it is desired to ensure data integrity. For example, in FIG. 3A, tracking processes can execute at Network database 214 and at archival database 210. Note that tracking processes, or other processes used with the present invention, can vary depending on the purpose, format, operation and other characteristics of a given datastore. The processes act to create a log of events and to transfer the log to secondary data sites, not shown. However, tracking processes can also be used at, e.g., routing processors such as routing processor 302 of FIG. 3B, or at any component in FIGS. 3A and 3B.

Although the invention has been described with respect to specific embodiments thereof, these embodiments are illustrative, and not restrictive, of the invention. For example, although application programs have been discussed as a process that transfers events to a database server, any type of process that makes a request, issues a command, or performs other communication with a database server is appropriate for use with the present invention. Although events have been described as resulting in transactions between the database server and the data store, the events need not always generate a transaction.

Thus, the scope of the invention is to be determined solely by the claims.

What is claimed is:

1. A method for keeping a copy of data, wherein a primary database server is coupled to a primary data store, wherein the primary database server receives database events from an external source and generates signals for accessing the primary data store, the method comprising
using the tracking process to store at least a portion of the received database events in an event log; and
using the event log to update a secondary data store.

2. The method of claim 1, further comprising
excluding some of the events from being stored in the event log.

3. The method of claim 2, further comprising
wherein the step of excluding some of the events in the event log includes the substep of allowing a user to define which events are excluded.

4. The method of claim 1, wherein the external source includes an application program.

5. The method of claim 4, wherein the application program is part of a messaging network.

6. The method of claim 1, further comprising
updating multiple secondary data stores.

7. In a distributed networked computer system, a method for exchanging messages in said networked computer system, said process comprising the steps of:
providing information to be sent from a source to a destination, said source and said destination coupled to said distributed networked computer system;
generating a message at said source, said message comprising the information and routing information;
transmitting said message to a selected route point in said distributed computer network using a first communication backbone;
transmitting said message to at least one additional selected route point in said distributed computer network using a second communication backbone;
archiving said message at each route point;
transmitting said message from route point to said destination;
eliminating duplicate copies of said message at said destination;
generating an event log including information about said archiving; and
using the event log to update a secondary data store.

8. A method for maintaining copies of data, wherein an application program sends events to a database server, wherein the database server generates database transactions to modify a primary copy of data, the method comprising
storing a record of the events as an original event log; and
using the original event log to maintain multiple copies of the data.

9. The method of claim 8, further comprising
transferring at least a portion of the record of events to multiple data sites, wherein each data site includes a data store, wherein each data store includes at least a portion of the data; and
using the transferred at least a portion of the record of events to update the data at the data stores.

10. The method of claim 9, wherein at least one data site receives events from two or more data sites.

11. The method of claim 10, wherein a secondary data site receives a series of events in an order different from the order of events in the original event log, the method comprising
using the received different-order events to update data at the secondary data site.
